(19) United States
(12) Patent Application Publication
(10) Pub. No.: US 2023/0316081 A1
(43) Pub. Date: Oct. 5, 2023

(54) Meta-Learning Bi-Directional Gradient-Free Artificial Neural Networks

(71) Applicant: Google LLC, Mountain View, CA (US)

(72) Inventors: Mark Sandler, Mountain View, CA (US); Andrey Zhmoginov, Mountain View, CA (US); Thomas Edward Madams, Seattle, WA (US); Maksym Vladymyrov, San Francisco, CA (US); Nolan Andrew Miller, Seattle, WA (US); Blaise Aguera-Arcas, Seattle, WA (US); Andrew Michael Jackson, Seattle, WA (US)

(21) Appl. No.: 18/011,873

(22) PCT Filed: May 6, 2022
(86) PCT No.: PCT/US2022/028126

§ 371 Date: Dec. 21, 2022

Related U.S. Application Data
(60) Provisional application No. 63/185,745, filed on May 7, 2021.

(51) Int. Cl. G06N 3/084; G06N 3/04

(52) U.S. Cl. CPC G06N 3/084; G06N 3/04

(57) ABSTRACT

The present disclosure provides a new type of generalized artificial neural network where neurons and synapses maintain multiple states. While classical gradient-based backpropagation in artificial neural networks can be seen as a special case of a two-state network where one state is used for activations and another for gradients with update rules derived from the chain rule, example implementations of the generalized framework proposed herein may additionally: have neither explicit notion of nor ever receive gradients; contain more than two states; and/or implement or apply learned (e.g., meta-learned) update rules that control updates to the state(s) of the neuron during forward and/or backward propagation of information.

### RELATED APPLICATIONS

This application claims priority to and the benefit of U.S. Provisional Application No. 63/185,745, filed May 7, 2021. U.S. Provisional Application No. 63/185,745 is hereby incorporated by reference in its entirety.

### FIELD

The present disclosure relates generally to artificial neural networks. More particularly, the present disclosure relates to meta-learning bi-directional gradient-free artificial neural networks.

### BACKGROUND

Artificial neural networks have revolutionized the way machine learning systems are built. Advances in neural design patterns, training techniques, and hardware performance have allowed machine learning techniques to solve tasks that seemed hopelessly out of reach less than ten years ago. However, despite the rapid progress, the basic neuron-synapse design of artificial neural networks has remained fundamentally unchanged for nearly six decades, since the introduction of perceptron models in the 1950s and 60s that modeled the complicated biology of a synapse firing as a simple combination of a weight and a bias combined with a non-linear activation function.

With such models, the next question was “How should we best find the optimal weights and biases?” and great successes have come from the early loss-minimization technique of stochastic gradient descent. Since its introduction, many of the more recent remarkable improvements can be attributed to improving the efficiency of the gradient signal: adjusting connectivity patterns such as in convolutional artificial neural networks and residual layers, improved gradient analysis or optimizer design, and normalization methods.

All these methods improve the learning characteristics of the networks and enable scaling to larger networks and more complex problems. However the underlying principle behind these methods remained the same: minimize an engineered loss function using gradient descent.

### SUMMARY

Aspects and advantages of embodiments of the present disclosure will be set forth in part in the following description, or can be learned from the description, or can be learned through practice of the embodiments.

One example aspect of the present disclosure is directed to a computing system featuring a bi-directional artificial neural network. The computing system includes one or more processors and one or more non-transitory computer-readable media that collectively store: an artificial neural network comprising a plurality of neurons and configured to forward process input data in a forward direction and backward process feedback data in a backward direction opposite to the forward direction. At least a first neuron of the plurality of artificial neuron is configured to maintain a plurality of different states. A machine-learned forward transform parameter set includes one or more learned parameter values that control an amount of mixing between each of the plurality of different states of the first neuron during forward processing. A machine-learned backward transform parameter set comprises one or more learned parameter values that control an amount of mixing between each of the plurality of different states of the first neuron during backward processing. The one or more non-transitory computer-readable media that collectively store instructions that, when executed by the one or more processors, cause the computing system to execute the artificial neural network to forward process input data to generate a prediction for a task.

Another example aspect of the present disclosure is directed to one or more non-transitory computer-readable media that collectively store: an artificial neural network that includes a plurality of artificial neurons and configured to forward process input data in a forward direction and backward process feedback data in a backward direction opposite to the forward direction. At least a first neuron of the plurality of neurons is configured to maintain a plurality of different states. A learned update genome is associated with at least the first neuron and comprises one or more machine-learned parameter sets that control operation of at least the first neuron. The one or more machine-learned parameter sets comprise one or more of: a machine-learned forward transform parameter set comprises one or more learned parameter values that control an amount of mixing between each of the plurality of different states of the first neuron during forward processing; a machine-learned backward transform parameter set comprises one or more learned parameter values that control an amount of mixing between each of the plurality of different states of the first neuron during backward processing; a machine-learned pre-synaptic transform parameter set that controls forward updates to a plurality of forward synaptic weights associated with the first neuron; and a machine-learned post-synaptic transform parameter set that controls backward updates to a plurality of backward synaptic weights associated with the first neuron.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a generalization of an artificial neural network that performs chain-rule backpropagation of fully connected layers.

FIG. 1B depicts a generalized formulation of a bi-directional gradient-free artificial neural network according to example embodiments of the present disclosure.

FIGS. 2A and 2B depict example meta-learning techniques according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to a new type of generalized artificial neural network where neurons and synapses maintain multiple states. While classical gradient-based backpropagation in artificial neural networks can be seen as a special case of a two-state network where one state is used for activations and another for gradients with update rules derived from the chain rule, example implementations of the generalized framework proposed herein may additionally: have neither explicit notion of nor ever receive gradients; contain more than two states; and/or implement or apply learned (e.g., meta-learned) update rules that control updates to the state(s) of the neuron during forward and/or backward propagation of information. While the artificial neural networks described herein are in some inspired by biological structures, the artificial neural networks are not intended to replicate biological neurons.

As an example, in some implementations of the proposed framework, the synapses and neurons can be updated using a bidirectional Hebb-style update rule parameterized by a shared low-dimensional “genome”. For example, an example genome can include: a machine-learned forward transform parameter set that includes one or more learned parameter values that control an amount of mixing between each of the plurality of different states of the neuron during forward processing and/or a machine-learned backward transform parameter set that includes one or more learned parameter values that control an amount of mixing between each of the plurality of different states of the first neuron during backward processing.

The present disclosure demonstrates that the genomes described herein can be meta-learned from scratch, using, for example, conventional optimization techniques and/or evolutionary strategies, such as, e.g., CMA-ES. The resulting update rules generalize to unseen tasks and train faster than gradient descent based optimizers for several standard computer vision and synthetic tasks, thus providing improvements in the performance of artificial neural networks while also resulting in conservation of computing resources such as reduced consumption of processor cycles, memory space, and/or network bandwidth.

More particularly, the present disclosure proposes a different approach to artificial neural networks relative to the prevailing paradigm. While the proposed models still follow the general strategy of forwards and backwards signal transmission, the rules governing both forward and back-propagation of neuron activation can be learned (e.g., meta-learned) from scratch (e.g., as opposed to various hand-crafted rules developed over the past several decades). One key enabling factor is a generalization of the artificial neural network model concept, where each neuron can have multiple states. For example, gradient descent and the feedback alignment method prescribes a very specific interaction between state and synapses, where one state is used for forward activation and the other is used for feedback (i.e., gradient).

Instead, example aspects of the present disclosure define a much broader space of possible transformations that control the interaction between neurons' feed-forward and feedback signals. The parameter sets (e.g., matrices) controlling these interactions can be meta-parameters that are shared across both neurons and tasks. In the present disclosure, these meta-parameters can be referred to collectively as a “genome”. This re-framing opens up a new, more generalized space of artificial neural networks, allowing the introduction of arbitrary numbers of states and channels into neurons and synapses, which have their analogues in biological systems, such as the multiple types of neurotransmitters, or chemical vs. electrical synapse transmission.

The present disclosure demonstrates that effective genomes can be learned through meta-learning with just a few training tasks, either by using conventional off-the-shelf optimizers or evolutionary strategies. The resultant genomes can be used to train different networks on unseen tasks faster than comparably-sized gradient networks. The resulting system can learn to solve completely different tasks without ever having access to gradients. Finally, it is shown that even when the space of possible update rules does not include gradient-like update rules, genomes can still be found that can train networks to learn new tasks.

The systems and methods of the present disclosure provide a number of technical effects and benefits. As one example, artificial neural networks having update genomes generated according to the present disclosure have shown to be able to train on unseen tasks faster than comparably-sized gradient networks. Training the network faster will result in reduced consumption of computing resources such as process usage, memory usage, and/or network bandwidth. Thus the techniques described herein represent an improvement in the functioning of a computing itself and are specifically applied to improve computerized network performance.

Thus, the present disclosure provides a general protocol for updating nodes in an artificial neural network, yielding a domain of genomes describing many possible update rules, of which gradient descent is one specific example. Useful genomes can be identified by training networks on training tasks, and then their generalization can be evaluated on unseen tasks. Example experiments described in the Appendix show that it is possible to learn an entirely new type of artificial neural network that can be trained to solve complex tasks faster than traditional artificial neural networks of equivalent size, but without any notion of gradients.

The proposed approach can be combined with many existing model representations with differentiable or non-differentiable components. The present disclosure is the first work that customizes both inference and learning passes by successfully finding the update rule that governs both synapse and neuron activation updates, e.g., without relying on either explicit gradients or a predefined loss function.

The attached Appendix, which is fully incorporated into and forms a portion of this disclosure describes example implementations of the systems and methods described herein. The present disclosure is not limited to the example implementations described in the attached Appendix.

### Example Bi-Directional Artificial Neural Networks

An Example Generalization of Gradient Descent Using Neuronal State:

To learn a new type of artificial neural network, this section first formally defines an example space of possible configurations. The proposed space is a generalization of TEXT classical artificial artificial neural networks. For the purpose of clarity, this section abstracts from the standard layer structure of an artificial neural network, and instead assumes the network is essentially a bag-of-neurons [symbol] of n neurons with a connectivity structure defined by two functions: “upstream” neurons I(i)⊂ [symbol] that send their outputs to i, and the set of “downstream” neurons J(i)⊂ [symbol] that receive the output of i as one of their inputs. Thus, the synapse weight matrix wᵢⱼ can encode separate weights for forward and backward connections.

Normally we think of a neuron in an artificial artificial neural network as having a single scalar value, it turns out that one state is not enough once we incorporate a back-propagation signal, which uses both feed-forward state and feedback state to propagate through the network. The standard forward pass over a densely connected artificial neural network updates the state of each neuron j∈ [symbol] according to

$${h}_{j} = σ ( {\sum }_{i ∈ I ( j )} {w}_{ij} {h}_{i} ) , \qquad ( 1 )$$

where hⱼ is the activation for neuron j∈ [symbol] resulting from applying a function σ(⋅) to the product of the network weights wᵢⱼ and the incoming stimulus from I(j). Let us define h′ⱼ: =σ′(Σ_{i∈I(j)}wᵢⱼhᵢ) as a derivative of the activation with respect to its argument. Then the back-propagation of a loss function is given by

$$\frac{\partial L}{\partial {h}_{i}} = {\sum }_{j ∈ J ( i )} {w}_{ij} \frac{\partial L}{\partial {h}_{j}} {h}_{j}^{′} . \qquad ( 2 )$$

Lastly, gradient descent updates the synapses wᵢⱼ using

$${w}_{ij} ← {w}_{ij} - \tilde{η} \frac{\partial L}{\partial {h}_{j}} {h}_{j}^{′} {h}_{i} , \qquad ( 3 )$$

where \tilde{η} is a learning rate.

The procedure outlined above can be implemented using neurons with two states, i.e., each activation hᵢ is now replaced with a two-dimensional vector αᵢ=(αᵢ⁽¹⁾, αᵢ⁽²⁾). One of these states would be used for a feed-forward signal and another for a back-propagated feedback signal. During the forward pass we set αⱼ←(hⱼ, h′ⱼ) and during the backward pass the second state is updated multiplicatively using (2) as

$${a}_{i}^{( 2 )} ← \frac{\partial L}{\partial {h}_{i}} {h}_{i}^{′} = {a}_{i}^{( 2 )} {\sum }_{j ∈ J ( i )} {w}_{ij} {a}_{j}^{( 2 )} .$$

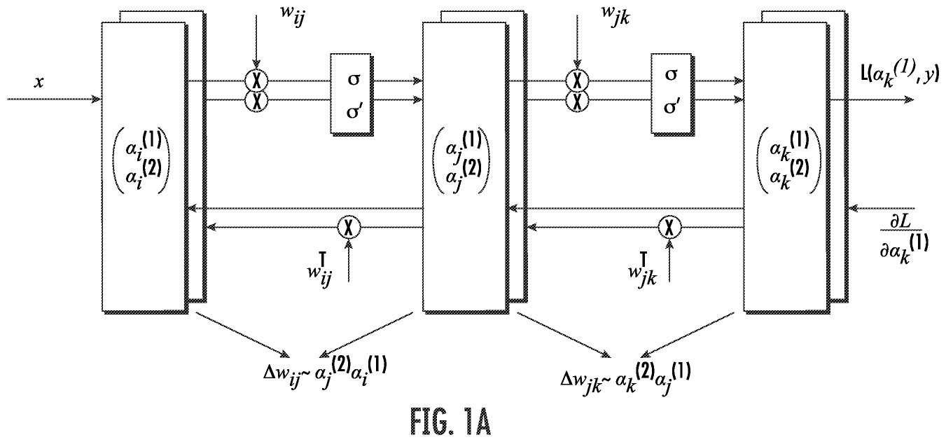

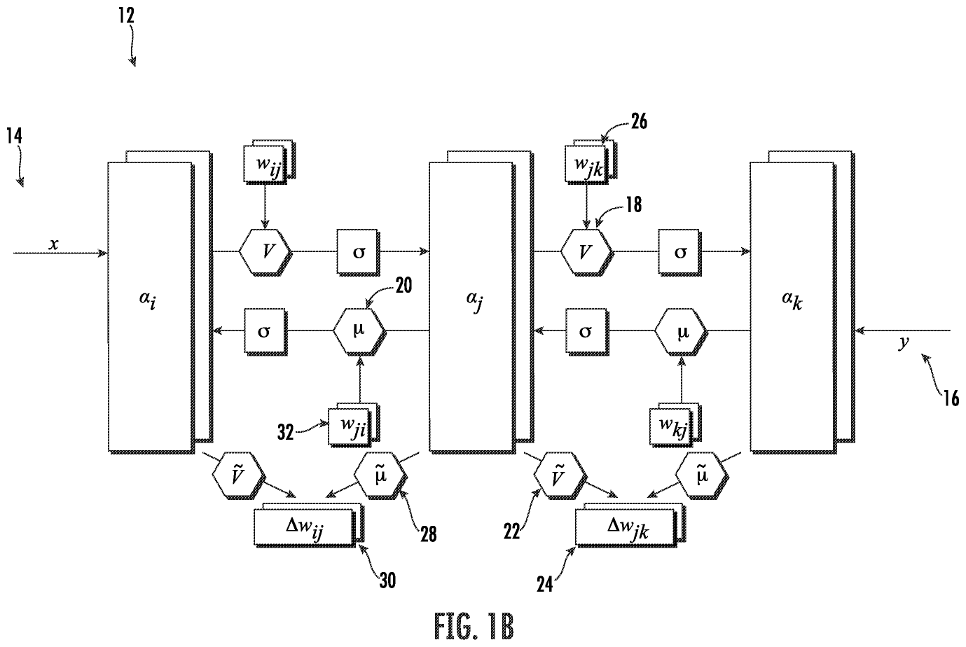

Then the synapses update is given by wᵢⱼ←wᵢⱼ−\tilde{η}αⱼ⁽²⁾αᵢ⁽¹⁾. FIG. 1A illustrates these described operations as a two-state artificial neural network.

One example includes defining the following constant matrices:

$$v = ( \begin{matrix}1 & 1 \\ 0 & 0\end{matrix} ) ,$$

$$\tilde{v} = ( \begin{matrix}1 \\ 0\end{matrix} ) ,$$

$$\tilde{μ} = ( \begin{matrix}0 \\ 1\end{matrix} )$$

and the following generalized binary activation function

$$ϕ ( ( \begin{matrix}x \\ y\end{matrix} ) ) = ( \begin{matrix}σ ( x ) \\ {σ}^{′} ( y )\end{matrix} ) .$$

Then the operations above can be equivalently rewritten as:

$${a}_{j}^{c} ← {ϕ}^{c} ( {\sum }_{i ∈ I ( j ) , d} {w}_{ij} {a}_{i}^{d} {v}^{cd} ) , \qquad ( 4 )$$

$$( forward )$$

$${a}_{i}^{( 2 )} ← {a}_{i}^{( 2 )} {\sum }_{j ∈ O ( i )} {w}_{ij} {a}_{j}^{( 2 )} ,$$

$$( backward )$$

$${w}_{ij} ← {w}_{ij} - \tilde{η} {\sum }_{e , d} {a}_{j}^{e} {\tilde{μ}}^{e} {a}_{i}^{d} {\tilde{v}}^{d} .$$

Thus, traditional gradient backpropagation can be expressed as a general two-state network, whose update rules are controlled by a predefined (and not-machine-learned) set of very low-dimensional matrices {v, \tilde{v}, \tilde{μ}, \tilde{η}}.

Example Multi-State Bidirectional Networks:

The two-state interpretation of the backpropagation algorithm outlined above is asymmetrical and contains several potentially biologically implausible design details like the use of the same weight matrix on the forward and backward passes and a multiplicative update during the backpropagation phase.

In contrast, the present disclosure proposes a general family of update rules that can: (a) use multi-channel asymmetrical synapses, (b) use the same update mechanisms on the forward and backward paths, and/or (c) allow for information mixing between different channels of each neuron. In its final state, one example implementation of such a family can be described by the following equations:

$${a}_{j}^{c} ← σ ( {fa}_{j}^{c} + η {\sum }_{i ∈ I ( j ) , d} {w}_{ij}^{c} {v}^{cd} {a}_{i}^{d} ) , \qquad ( 5 )$$

$$( forward )$$

$${a}_{j}^{c} ← σ ( {fa}_{j}^{c} + η {\sum }_{j ∈ O ( i ) , d} {w}_{ij}^{c} {μ}^{cd} {a}_{i}^{d} ) , \qquad ( 6 )$$

$$( backward )$$

$${w}_{ij}^{c} ← \tilde{f} {w}_{ij}^{c} + \tilde{η} {\sum }_{e , d} {a}_{i}^{e} {\tilde{v}}^{ec} \cdot {\tilde{μ}}^{cd} {a}_{j}^{d} . \qquad ( 7 )$$

FIG. 1B provides an example illustration of the proposed framework and Table 1 tracks the description and dimensionality of variables used in the formulae above. The matrices {f, \tilde{f}, f, v, \tilde{v}, μ, \tilde{μ}, η, \tilde{η})} used in (5)-(7) form an example of a complete genome G.

TABLE 1
Description and dimensions of variables used in the paper.

| | | |
|---|---|---|
| Name | Dimension | Description |

Constants

| | | |
|---|---|---|
| n | — | total number of neurons. |
| k | — | total number of states. |

Network params

| | | |
|---|---|---|
| aᵢ^{c} | i ∈ [n], c ∈ [k] | state c of neuron i. |
| wᵢⱼ^{c} | i, j ∈ [n], c ∈ [k] | channel c of synapse between |
| | | i and j. |

Meta-learning params (genome)

| | | |
|---|---|---|
| f, η | 1 | neuron forget and update gates. |
| \tilde{f}, \tilde{η} | 1 | synapses forget and update |
| | | gates. |
| ν^{cd}, μ^{cd} | c ∈ [k], d ∈ [k] | forward/backward neuron |
| | | transform matrix. |
| \tilde{ν}^{cd}, \tilde{μ}^{cd} | c ∈ [k], d ∈ [k] | pre-and post-synaptic |
| | | transform matrix. |

Some example implementations of the proposed framework can leverage some or all of the following generalizations with respect to the backpropagation update rules:

In some implementations, the neuron transform matrices v, μ and synapse transform matrices \tilde{v}, \tilde{μ} can all have dimension k×k and allow for mixing of every input state to every output state.

In some implementations, the genome can optionally be expanded to include f, η, \tilde{f}, \tilde{η} that control how much of the information is forgotten and how much is being updated after each step. While similar approaches have been generically studied, example implementations of the present disclosure are the first to learn these parameters (e.g., scalars) directly and do not model them as a function of a previous iteration.

Some example implementations perform an additive update for both neurons and synapses. Note that in order to generalize to backpropagation, an additive update for the backward pass has to be replaced with a multiplicative one and applied only to the second state. Experimentally, it was discovered that both additive and multiplicative updates perform similarly.

Some example implementations extend the activation function to be applied on both forward and backward pass and, to make things simple, make it unitary (same function applied to every state).

Some example implementations generalize the synapse matrices to be asymmetric for a forward and backward pass (wᵢⱼ≠wⱼᵢ) as well as contain more than one state. Symmetric weight matrices are ordinarily used for deep learning, but distinct weight matrices are much more biologically plausible. Other example implementations use symmetric weight matrices.

In some example implementations, the synapse update now has a general form of a Hebbian-update rule mixing pre- and post-synaptic activity.

In addition to generalizing existing gradient learning, not relying on gradients in backpropagation has additional benefits. For example, the network doesn't need to have an explicit notion of a final loss function. The feedback (e.g., ground truth) can be fed directly into the last layer (e.g. by additive update to the second state or simply by replacing the second state altogether) and the backward pass would take care of backpropagating it through the layers.

Since the proposed framework can use more than two states, it is hypothesized that just as the number of layers relates to the complexity of learning required for an individual task, the number of states might be related to complexity of learning behaviour (“how hard is a given task” vs “how hard it is to learn the task given a variety of other tasks available”).

The resulting proposed genome now completely describes the communication between individual neurons. The neurons themselves can be arranged in any of the familiar ways—in convolutional layers, residual blocks, etc.

To provide a highly simplified example, FIG. 1B shows an artificial neural network 12 comprising a plurality of neurons. Specifically, in the simplified example, the network 12 includes three neurons αᵢ, α₁, and αₖ.

The network 12 is configured to forward process input data 14 in a forward direction (shown left-to-right) and backward process feedback data 16 in a backward direction (shown right-to-left) that is opposite to the forward direction.

In the illustrated example, each neuron is configured to maintain a plurality of different states. For example, neuron αⱼ is configured to maintain two states, illustrated by the two gray rectangles layered on each other. Although two states are shown for simplicity, any number of states can be maintained. The number of states can be the same across all neurons or can vary across the neurons.

A learned update genome can control operation of the neuron αⱼ. The genome can be shared across all neurons, some neurons, or specific to the neuron αⱼ.

The update genome can include a machine-learned forward transform parameter set 18 that includes one or more learned parameter values to control an amount of mixing between each of the plurality of different states of the neuron αⱼ during forward processing.

As used herein, a parameter set comprises a set of parameter values. A learned parameter set can include one or more machine-learned values (e.g., meta-learned values). A parameter set can take various forms and/or can be applied using one or more operations. As a simple example, a parameter set can include a matrix of values (e.g., a binary matrix) and application of the parameter set can include multiplication of the matrix against a set of input values. In a more complex example, the parameter set can be structured as a machine-learned model such as an artificial neural network. A parameter set can approximate or be applied as a function.

The update genome can also include a machine-learned backward transform parameter set 20 that includes one or more learned parameter values that control an amount of mixing between each of the plurality of different states of the neuron αⱼ during backward processing.

The update genome can also include a machine-learned pre-synaptic transform parameter set 22 that controls forward updates 24 to a plurality of forward synaptic weights 26 associated with the neuron αⱼ.

The update genome can also include a machine-learned post-synaptic transform parameter set 28 that controls backward updates 30 to a plurality of backward synaptic weights 32 associated with the first neuron.

In some implementations, some or all of the parameter sets included in the update genome have been learned by performance of a meta-learning technique.

In some implementations, the update genome can further include one or more of: a machine-learned neuron forget parameter set; a machine-learned neuron update parameter set; a machine-learned synapses forget parameter set; and a machine-learned synapses update parameter set.

In some implementations, at least two of the plurality of different states of some or all of the neurons operate over at least two different time scales.

In some implementations, the artificial neural network 12 is configured to simultaneously forward process the input data 14 in the forward direction and backward process the feedback data 16 in the backward direction. In some examples, the feedback data 16 can include gradient-free feedback data. In some examples, the feedback data 16 can include a ground truth output for a task. The network 12 can forward process the input data 14 to produce a prediction for the task.

Example Meta-Learning of a Genome

Now that the space of possible update rules has been defined, the next step is to design an algorithm to find a genome that can solve some problems. One example approach focuses on meta-learning genomes that can solve classification problems with multiple hidden layers. To avoid confusion, the bag-of-neurons notation from the previous section will continue to be used.

To provide an example, for a d-class classification problem with 1-dimensional input, the first layer can be used as input and the last layer with d neurons can be used as predictors. Those neurons can be denoted as x₁ . . . xₗ and y₁ . . . y_{d} respectively. The first state of each neuron α_{y}_{ᵢ}⁽⁰⁾ can then be treated as logit predictions for class i, where ax represents the i-th feature of the input. During the learning process, in a forward pass equation (5) can be applied to compute a logit prediction, and during a backward pass, 1 or −1 can be passed in the second state of yᵢ-th neuron, depending on whether the input is of class i independently of the logit prediction. In implementations where there are more than two states per neuron, the other states of non-hidden layers can be left empty. Equations (6) and (7) can then be used to compute updated synapse state.

To evaluate the quality of genome equations (5)-(7) can be applied for multiple unroll steps and then the quality of the resulting prediction on a previously unseen set of inputs can be measured. To meta-learn using SGD standard softmax-cross entropy loss: Lₘₑₜₐ(G)=Eₛ[pᵢ(s)logα_{y}_{ᵢ}⁽⁰⁾(s)] can be used, where pᵢ(s) is one-hot vector representing the true category for sample s, and α_{y}_{ᵢ}⁽⁰⁾(s) is the forward activation on unseen sample after the forward and backward updates for s unroll steps have been applied. This function can be minimized with standard off-the-shelf optimizers to find an optimal genome.

The attached Appendix includes experiments using CMA-ES where training accuracy was used as a fitness metric.

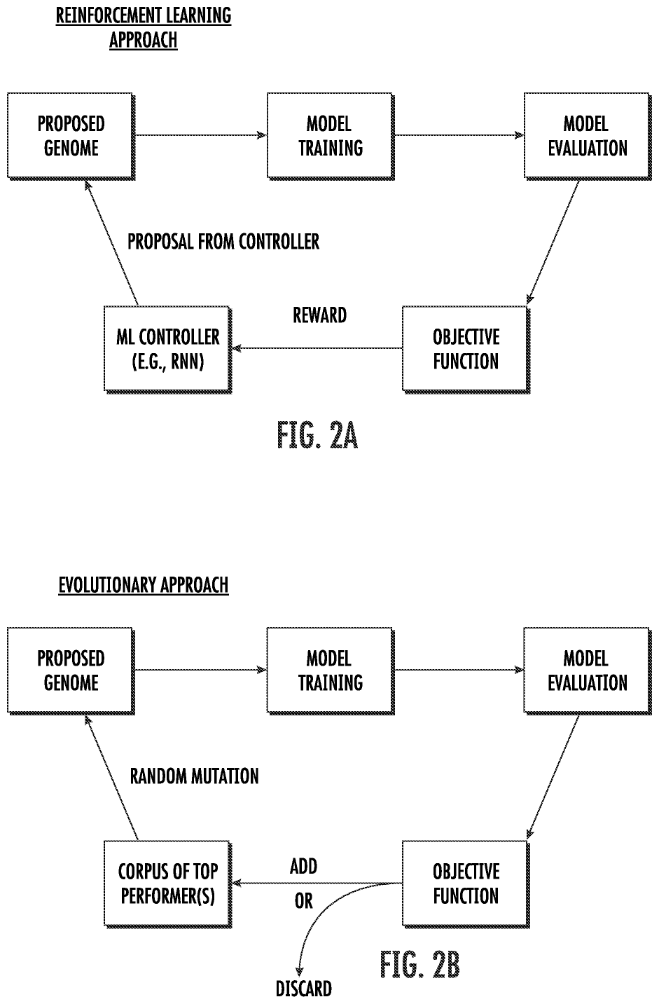

Thus, to provide examples, FIGS. 2A and 2B illustrate example meta-learning approaches. In FIG. 2A, a machine-learned controller model can propose a new genome. A model (e.g., artificial neural network) having the genome can then be trained (e.g., via the multiple unrolling steps described above). The model can then be evaluated (e.g., using the SGD softmax-cross entropy loss described above). An objective function can also be evaluated (e.g., the objective function may be the same as the model evaluation or may be a function of the model evaluation). A reward determined using the objective function can be provided to the machine-learned controller which can be updated and/or generate a new proposed genome based on the reward.

In FIG. 2B, the process is similar except that instead of using a controller to propose a new genome, a random mutation can be used to generate a proposed genome. Likewise, instead of determining a reward for the controller as shown in FIG. 2A, in FIG. 2B, the objective function can be used to determine whether to add the current genome to a corpus from which mutations occur, or to discard the genome (e.g., training accuracy can be used as a fitness metric/objective function). Addition of the genome to the corpus can optionally result in removal of a lowest performing genome currently included in the corpus.

Example Activation Normalization and Synapse Saturation:

Synapse updates that rely on Hebb's rule alone (Δwᵢⱼ˜αᵢαⱼ) are generally unstable, as network weights w grow monotonically with the training steps. One way to alleviate this issue while also reducing the sensitivity of network outputs to small synapse perturbations is to use activation normalization. Normalization techniques are widely used in conventional deep neural architectures. In most of the experiments described in the Appendix, per-channel normalization similar to batch-normalization was used to normalize a pre-nonlinearity activation distribution into one with a learnable mean and deviation. This not only helps in training deeper models, but also allows learned update rules to generalize to different input sizes.

However, activation normalization alone does not always prevent an unbounded synapse weight growth, and so another mechanism for weight saturation may in some situations be necessary. One such approach is based on using Oja's update rule that modifies Hebb's rule with an additional component that by itself leads to the decay of the singular components of the weight matrix. One of the most commonly used form of Oja's update rule is Δwᵢⱼ=γαᵢαⱼ−γαⱼ²wᵢⱼ however there also exist other forms with similar properties. In linear systems, the interplay of the excitatory and inhibitory driving forces leads to synapse saturation. But in our case, the linear component of the update rule \tilde{f}w along with the usage of nonlinearities (like tanh) or activation normalization may prevent the original Oja's rule from saturating model weights. The same principles that were used to derive Oja's rule can also be applied to the proposed system and result in the following inhibitory Oja-like update:

$${( {Δ w}_{ij}^{c} )}^{Oja} = - ( \tilde{f} - 1 ) {w}_{ij}^{c} {\sum }_{k} {( {Δ w}_{ij}^{c} )}^{2} - \tilde{η} {w}_{ij}^{c} {\sum }_{k , e , d} {w}_{kj}^{c} {a}_{k}^{e} {\tilde{v}}^{ec} {\tilde{μ}}^{cd} {a}_{j}^{d} . \qquad ( 8 )$$

Since in practice, the first component of this update usually dominates the second component, the described experiments only used this term with an additional learnable multiplier.

Also notice that Oja's term is generally derived as an inhibitory additive component that acts as a “counterweight” to the Hebbian synapse update and keeps the weight norm fixed. Instead of using such inhibitory terms, some example implementations of the present disclosure instead apply normalization and saturating nonlinearities (like αtanh(x/α) with a learnable α coefficient) directly to the synapses. The described experiments empirically validated that both approaches lead to very similar results and could thus potentially be used interchangeably.

Example Comparison of Update Rule with a Gradient Descent

Once meta-learning has been used to identify a promising genome, one might ask if the resulting training algorithm is in fact identical to a conventional gradient descent with some unknown loss function L_{equiv}. This section empirically demonstrates that the answer is generally no. Consider a full-batch training scenario and let Δwᵢⱼ^{c}(ŵ; a) be the weight update rule defined by our learned genome, equivalence to gradient descent would then mean that:

$${Δ w}_{ij}^{c} = - γ \frac{\partial {L}_{equiv}}{\partial {w}_{ij}^{c}} \qquad ( 9 )$$

and therefore

$$\frac{\partial {w}_{ij}^{c}}{\partial {w}_{mn}^{d}} = - γ \frac{\partial {L}_{equiv}}{\partial {w}_{ij}^{c} \partial {w}_{mn}^{d}} .$$

Since the partial derivatives are symmetric, we see that

$$\frac{\partial {w}_{ij}^{c}}{\partial {w}_{mn}^{d}} = \frac{\partial {w}_{mn}^{d}}{\partial {w}_{ij}^{c}} \qquad ( 10 )$$

is a necessary condition for the existence of the loss L_{equiv} satisfying Eq. (9). This condition can be tedious to verify analytically, but we can instead check it numerically. Computing |∂Δwᵢⱼ^{c}/∂wₘₙ^{d}−∂Δwₘₙ^{d}/∂wᵢⱼ^{c}| in a simple experiment with Boolean functions and a single hidden layer of size 20, we verified that the discovered update rules do not satisfy condition (10) (see FIG. 1) and therefore L_{equiv} does not generally exist for our update rule family.

### Example Devices and Systems

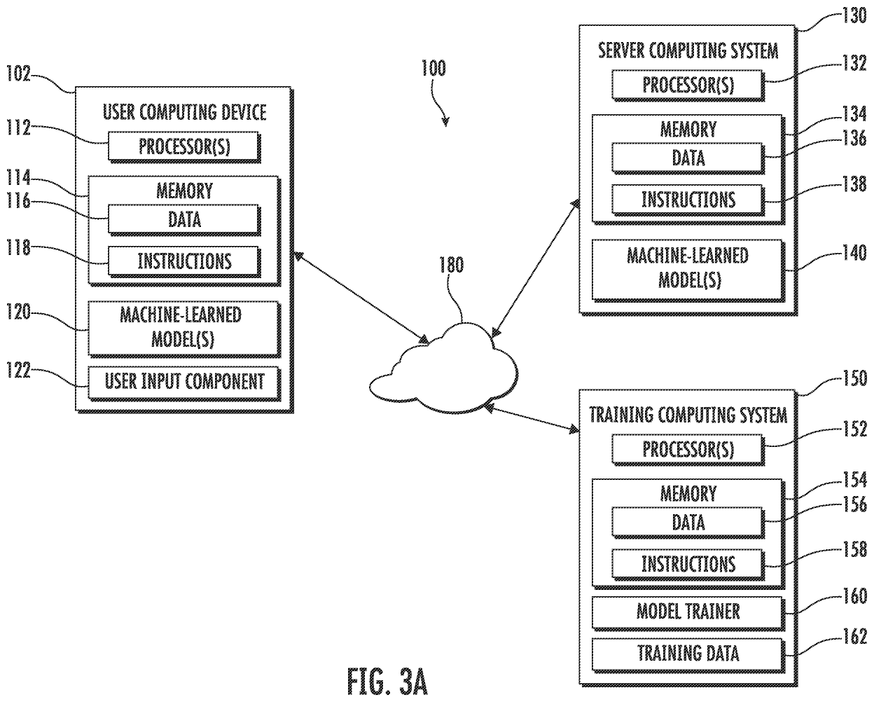

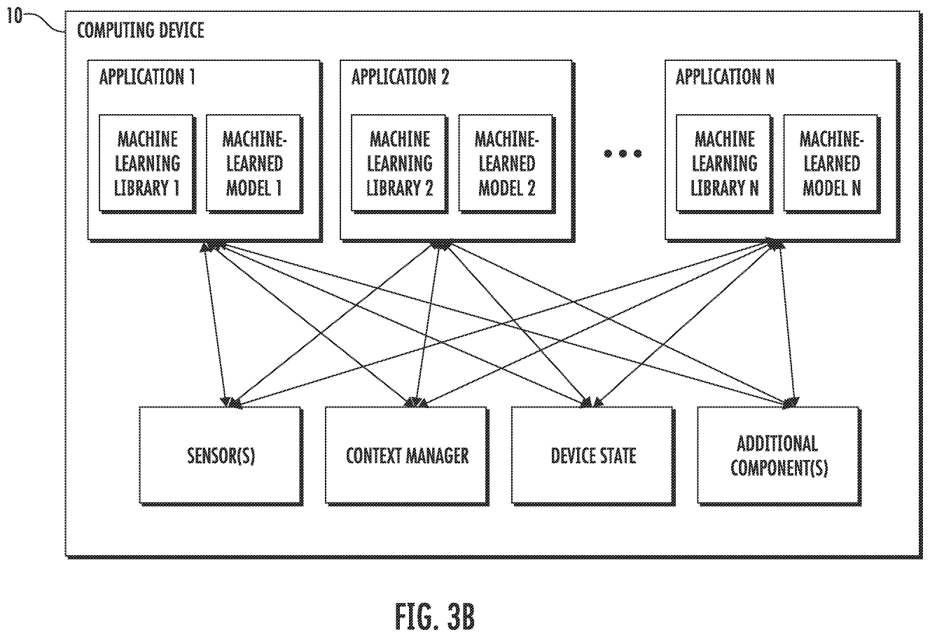

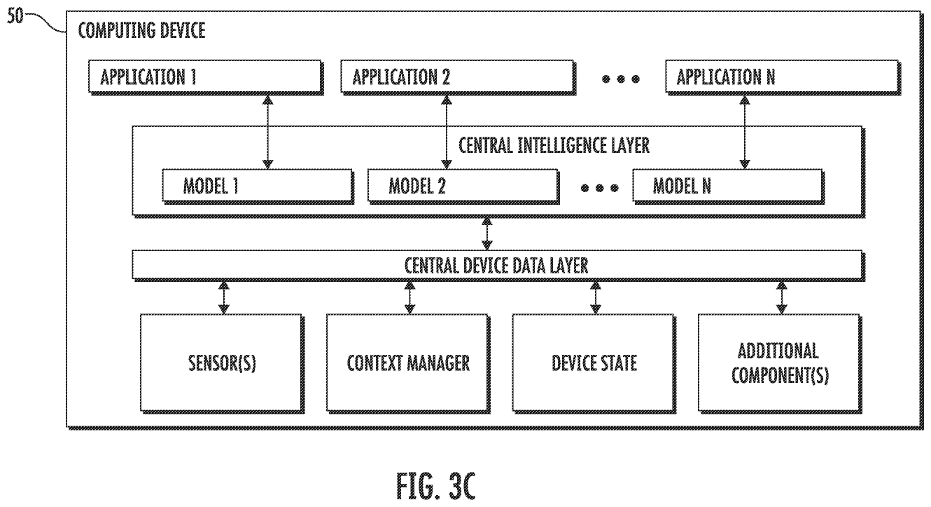

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as artificial neural networks (e.g., deep artificial neural networks) or other types of machine-learned models, including non-linear models and/or linear models. Artificial neural networks can include feed-forward artificial neural networks, recurrent artificial neural networks (e.g., long short-term memory recurrent artificial neural networks), convolutional artificial neural networks or other forms of artificial neural networks. Some example machine-learned models can leverage an attention mechanism such as self-attention. For example, some example machine-learned models can include multi-headed self-attention models (e.g., transformer models). Example machine-learned models 120 are discussed with reference to FIG. 1B.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include artificial neural networks or other multi-layer non-linear models. Example artificial neural networks include feed forward artificial neural networks, deep artificial neural networks, recurrent artificial neural networks, and convolutional artificial neural networks. Some example machine-learned models can leverage an attention mechanism such as self-attention. For example, some example machine-learned models can include multi-headed self-attention models (e.g., transformer models). Example models 140 are discussed with reference to FIG. 1B.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backward propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backward propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model. Training the model can include participating in a federated learning approach to collectively re-train the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system featuring a bi-directional artificial neural network, the computing system comprising:
one or more processors; and
one or more non-transitory computer-readable media that collectively store:
an artificial neural network comprising a plurality of neurons and configured to forward process input data in a forward direction and backward process feedback data in a backward direction opposite to the forward direction;
wherein at least a first neuron of the plurality of neurons is configured to maintain a plurality of different states;
wherein a machine-learned forward transform parameter set comprises one or more learned parameter values that control an amount of mixing between each of the plurality of different states of the first neuron during forward processing; and
wherein a machine-learned backward transform parameter set comprises one or more learned parameter values that control an amount of mixing between each of the plurality of different states of the first neuron during backward processing; and
instructions that, when executed by the one or more processors, cause the computing system to execute the artificial neural network to forward process input data to generate a prediction for a task.

2. The computing system of claim 1, wherein the plurality of different states comprise three or more different states.

3. The computing system of claim 1, wherein one or both of the machine-learned forward transform parameter set and the machine-learned backward transform parameter set have been learned by performance of a meta-learning technique.

4. The computing system of claim 1, wherein machine-learned forward transform parameter set and the machine-learned backward transform parameter set are included in an update genome associated with the first neuron.

5. The computing system of claim 4, wherein the update genome is shared across the first neuron and one or more other neurons of the plurality of neurons.

6. The computing system of claim 5, wherein the update genome is shared across all of the plurality of neurons.

7. The computing system of claim 4, wherein the update genome further comprises a machine-learned pre-synaptic transform parameter set that controls forward updates to a plurality of forward synaptic weights associated with the first neuron.

8. The computing system of claim 4, wherein the update genome further comprises a machine-learned post-synaptic transform parameter set that controls backward updates to a plurality of backward synaptic weights associated with the first neuron.

9. The computing system of claim 7, wherein one or both of the machine-learned pre-synaptic transform parameter set and the machine-learned post-synaptic function comprise a binary mixing matrix.

10. The computing system of claim 4, wherein the update genome further comprises one or more of:
a machine-learned neuron forget parameter set;
a machine-learned neuron update parameter set;
a machine-learned synapses forget parameter set; and
a machine-learned synapses update parameter set.

11. The computing system of claim 1, wherein one or both of the machine-learned forward transform parameter set and the machine-learned backward transform parameter set comprise a binary mixing matrix.

12. The computing system of claim 1, wherein at least two of the plurality of different states operate over at least two different time scales.

13. The computing system of claim 1, wherein the artificial neural network is configured to simultaneously forward process the input data in the forward direction and backward process the feedback data in the backward direction.

14. The computing system of claim 1, wherein the feedback data comprises gradient-free feedback data.

15. The computing system of claim 1, wherein the feedback data comprises a ground truth output for the task.

16. One or more non-transitory computer-readable media that collectively store:
an artificial neural network comprising a plurality of neurons and configured to forward process input data in a forward direction and backward process feedback data in a backward direction opposite to the forward direction;
wherein at least a first neuron of the plurality of neurons is configured to maintain a plurality of different states; and
wherein a learned update genome is associated with at least the first neuron and comprises one or more machine-learned parameter sets that control operation of at least the first neuron;
wherein the one or more machine-learned parameter sets comprise one or more of:
a machine-learned forward transform parameter set comprises one or more learned parameter values that control an amount of mixing between each of the plurality of different states of the first neuron during forward processing;
a machine-learned backward transform parameter set comprises one or more learned parameter values that control an amount of mixing between each of the plurality of different states of the first neuron during backward processing;
a machine-learned pre-synaptic transform parameter set that controls forward updates to a plurality of forward synaptic weights associated with the first neuron; and
a machine-learned post-synaptic transform parameter set that controls backward updates to a plurality of backward synaptic weights associated with the first neuron.

17. The one or more non-transitory computer-readable media of claim 16, wherein the plurality of different states comprise three or more different states.

18. The one or more non-transitory computer-readable media of claim 16, wherein the learned update genome has been learned by performance of a meta-learning technique.

19. The one or more non-transitory computer-readable media of claim 16, wherein one or both of the machine-learned forward transform parameter set and the machine-learned backward transform parameter set comprise binary mixing matrices.

20. The one or more non-transitory computer-readable media of claim 16, wherein the artificial neural network is configured to simultaneously forward process the input data in the forward direction and backward process the feedback data in the backward direction.
